(19) United States
(12) Patent Application Publication
(10) Pub. No.: US 2014/0200937 A1
(43) Pub. Date: Jul. 17, 2014

(54) METHOD AND SYSTEM FOR REQUESTING PRODUCTS AND SERVICES AND RATING EMPLOYEES AND SERVICE LOCATIONS KEYED TO IDENTIFICATION TAGS

(71) Applicant: Robert Friedman, Laguna Hills, CA (US)

(72) Inventor: Robert Friedman, Laguna Hills, CA (US)

(21) Appl. No.: 13/742,429

(22) Filed: Jan. 16, 2013

(51) Int. Cl. G06Q 30/00

(52) U.S. Cl. CPC G06Q 30/016; G06Q 10/06398
USPC 705/7.13; 705/304; 705/7.42

(57) ABSTRACT

Disclosed is a method and system for entering customer service requests, ratings and reviews in a quality control system, keyed to employee-specific or service location-specific identification numbers stored on physical media such as QR codes, bar codes, and RFID tags, and to notify employees of service requests for prompt resolution. Also disclosed is a system and method for using such employee-specific and service location-specific data to produce numerical measurements of quality, and to convert those measurements to points that may be exchanged for rewards, incentivizing good service and participation in the quality control system.

### TECHNICAL FIELD

Embodiments of the present invention relate to the field of computer-based collection of customer feedback and requests for service, and particularly to the use of digitally readable identification badges to track employee or location-specific service requests customer feedback regarding products or services rendered.

### BACKGROUND ART

Any business that sells products or services can benefit from systematically collected customer feedback. However, paper-based customer feedback suffers from many logistical drawbacks, and the digital systems invented to replace them still require further refinement.

Prior to computerization, feedback would be collected either orally, or in the form of writing on paper. Oral customer feedback will no doubt always exist whether businesses are prepared to accept it or not, but it is far from ideal for companies wishing to improve their customer service practices. Oral communication is inherently difficult to organize into a standard form when it is administered, and is equally challenging to store and file in an orderly manner. The use of customer-satisfaction survey forms on paper is far more systematic, and even allows the conversion of customer opinions to a quantitative form, using such means as requesting that customers rate various categories of service quality on a numerical scale. Those ratings can be added together and averaged, allowing proprietors to see at a glance where their service has been wanting. The forms can be filed, kept in order, and referred to in the future as needed.

Paper-based customer service feedback forms, however, have many drawbacks. First, it can be difficult to induce the customers to fill them out, as the process can be lengthy and the forms must generally be filled out by hand. Second, where the surveys are being collected at a large number of locations, organizing them, adding up the numbers, and reviewing comments to learn the details of particular experience becomes logistically challenging. Paper is bulky as data storage, so files occupy increasing amounts of space. Paper is not searchable like digital content; it is of course possible to index paper records, but producing indexes is an arduous process requiring hours of labor; when paper records are sufficiently voluminous it becomes practically impossible.

It is hardly surprising that many have turned to computerized feedback collection in response to the issues described above. Particularly in internet commerce, the use of “star ratings” by customers to quantify their degree of satisfaction is ubiquitous. These ratings are generally averaged and displayed on websites offering products and services, or on independent websites that exist solely for the purpose of displaying customer reviews. A quick perusal of such sites demonstrates the advantages of this approach. A customer who sees a low average rating for a product can see how many overall ratings occurred, to eliminate problems of sample size, and can read comments pertaining to any rating level to decide for him or herself whether the ratings that accompanied those comments had merit. In such cases, automation has given every person with internet access superior abilities to monitor customer feedback than paper surveys gave to the very owners of the businesses receiving them.

Solutions have also evolved for internal use by the business themselves. Retailers commonly track consumers' buying patterns using discount cards that are scanned on every transaction; the same tracking functionality is of course inherent on any internet page that requires customers to log on before purchasing. The wealth of data collected by these means can be augmented by convincing customers to leave feedback after completing a sale. In the case of brick-and-mortar stores, customers may be offered incentives, such as a chance to win a gift card, to fill out surveys at in-store computer terminals, or on the internet at their leisure. Consumers also receive emails requesting them to review items, or are prompted to enter reviews on the same website at which they purchased them. The reviews can be very finely linked to the products to which they pertain, because products have been tracked by numerical codes for decades. Virtually every product sold now has a bar code on it containing a number unique to products of its exact make and model, and that number in may be scanned optically or entered manually into electronic systems, lending an impressive degree of precision to product tracking and reviews. Software collating and processing all of this data provides executives and customer service specialists with a wealth of information concerning customer interest and satisfaction with regard to products.

Reviewing and tracking services has remained a less precise endeavor. Customers who leave reviews concerning service typically have to remember the names of employees and the locations of service for themselves; while this might not seem arduous, it lacks the automatic precision with which businesses currently track products and even customers. In some professions, particular persons are associated with numerical codes. For instance, lawyers have registration numbers in every bar to which they are admitted, and police officers have badge numbers. Likewise in some instances the location where a service takes place can have an identification of its own, such as the medallion of a taxi, or the room number in a hotel. But these numbers, in contrast to the Universal Product Code (UPC) numbers tracking products, remain primarily in the analog world; customers who wish to make use of them must remember or write them down. One recent proposal calculated to rectify this gap involves giving each service transaction an identification number that could be presented in physical form and scanned; although this may enhance the ability to track certain kinds of activity, it does not duplicate the effortlessness of the UPC system, as it would require that an entirely new identification number be generated for each service transaction, and thus would not group the transactions by category as efficiently as product tracking currently does. Furthermore, the service transaction identification would not assist in providing feedback specific to employers or service locations, which would remain shrouded in numerical anonymity.

The inability to track things like employees and taxicabs also makes orders for services less elegant than product orders. Customers are in a position now to take for granted their ability to choose and request precisely what they want when ordering products, because their order is supported on an automated system of digital tracking so efficient as to be nearly invisible. The same degree of precision is lacking when services are involved. The customer must rely on his or her own memory in order to request the services of a particular employee or to get in contact with a particular service location.

### SUMMARY OF THE EMBODIMENTS

It is therefore an object of the present invention to provide a convenient way to create and track employee and service location specific service request and feedback data in a wide variety of service settings. It is a further object of this invention to create an employee and service-location tracking system that matches the automatic ease of the systems already in place to track products. It is a yet further object of this invention to provide positive incentives to employees to improve service, and to participate in quality control measures to improve customer experience throughout the service industry.

The first embodiment of this invention is a method performed by one or more programmable electronic devices, such as smartphones or computers, in which an employee or service location is equipped with a QR code, RFID tag, or similar device that is digitally scanned using the appropriate hardware to enter a number identifying the employee or service location into the device. This primes the device to receive customer input regarding the employee or location to which the identification number pertains. The customer subsequently enters some data pertaining to the service transaction using the electronic device's keyboard or touchscreen or similar input means. Each time the customer enters data, the date and time of entry is added to the data, which is saved to a database. Finally, when the service transaction concludes, somebody ends the session for the device, disassociating that identification number from subsequently entered data.

In an additional embodiment of the disclosed method, the customer data includes requests for service by the employee or by people staffing the service location pertaining to the identification that was scanned. A further embodiment entails messaging at least one employee with a service request. The data in another embodiment includes feedback concerning the same employee or service location. A third kind of data in some embodiments consists of customer contact information, such as email, so that customers can be sent special offers and information later on. An additional embodiment involves scanning additional identifiers from different badges, and adding those identifiers to any subsequently produced custom data files during the session. Another embodiment involves storing and maintaining in the database information linking identifiers to each other based upon the work relationships between the corresponding employees and service locations, to aid clients in seeing how the feedback reflects not only on the immediate employee or service location being reviewed, but on others related to him, her, or it. Still another embodiment entails retrieving past data records and related information (including, for example, the associative data described in the preceding sentence) and displaying them on the device's display. Those retrieved records are sorted according to an additional embodiment, and under still another are filtered by data fields. A further embodiment allows users to edit the data fields thus recovered, modifying the files relating to that data, adding the date and time of modification, and saving the modified file to the database again.

Still another embodiment of the claimed method involves using the customer data entered to create numerical measures of individual performance, keyed to the identification numbers entered. A further method uses those measures to assign rewards points to employees, and maintain them in a database as a balance that may, in a final method embodiment, be exchanged for goods and services to incentivize participation by the employees in the claimed method, and to incentivize good service. In the final embodiment, the price of a given reward is deducted from the employee's rewards point balance.

Also claimed is a system for entering employee and service-location specific feedback and service requests, which includes one or more programmable electronic devices such as computers or smartphones, each of which has a processor and a memory. A part of the system is at least one QR code, RFID tag, or similar object that may be scanned to extract an identification number, along with the hardware necessary to scan the number in. The electronic device or devices are configured using a computer program to possess a User Interface Component to display data and to prompt its entry, an Identifier Capture Component to store in memory the numerical identification to be scanned, a Manual Entry Component to capture customer data and commands to terminate service sessions, a Processing Component to initiate and terminate service sessions, to combine customer-entered data with the identification numbers in data files, and to add the date and time of entry to those files, and Data Storage Component that stores the data files to a database coupled to the electronic device.

The customer data in another system embodiment includes service requests. A further embodiment involves configuring the Processing Component to message employees regarding service requests. Another embodiment includes customer feedback in the customer data the system is designed to receive. Still another embodiment includes customer contact information in the customer data for which the system is designed. An additional embodiment involves configuring the Identifier Capture Component to capture additional identifiers, configuring the Processing Component to add the additional identifiers to a service session that has already been created, and to add them to all subsequent custom data files, and configuring the Data Storage Component to store the data files so modified. Yet another embodiment involves configuring the Data Storage Component to store data linking identifiers to one another based upon employees' and service locations' work-relationships, and the use of a database to store that data. In a further embodiment, the Data Storage Component is capable of retrieving previously entered data files and related data (including the associative data described in the preceding sentence) associated with a particular identification number from the database. An additional embodiment permits the Processing Component to sort those data files, while still another embodiment enables the Processing Component to filter the data files according to values of specified fields. Under another embodiment, the Manual Entry Component is able to accept an alteration of at least one data field in one of the data files, the Processing Component is designed to amend the data field according to the alteration in the data file and to add the data time of entry, and the Data Storage Component is set up to store the altered data file in the database. In another embodiment, the Processing Component is further designed to calculate measures of quality of service for a given identification number. A further embodiment enables the Processing Component to use those measures to assign rewards points to an employee identified by the identification number, and the Data Storage Component to save the balance of such points in a database. A final embodiment enables the User Interface Component to display potential reward selections for the employee to purchase with rewards; the Manual Entry Component accepts rewards selections, the Processing Component subtracts their prices from the rewards balance, and the Data Storage Component saves the modified balance to the database again.

Other aspects, embodiments and features of the invention will become apparent from the following detailed description of the invention when considered in conjunction with the accompanying figures. The accompanying figures are for schematic purposes and are not intended to be drawn to scale. In the figures, each identical or substantially similar component that is illustrated in various figures is represented by a single numeral or notation. For purposes of clarity, not every component is labeled in every figure. Nor is every component of each embodiment of the invention shown where illustration is not necessary to allow those of ordinary skill in the art to understand the invention.

Other aspects, embodiments and features of the invention will become apparent from the following detailed description of the invention when considered in conjunction with the accompanying figures. The accompanying figures are for schematic purposes and are not intended to be drawn to scale. In the figures, each identical or substantially similar component that is illustrated in various figures is represented by a single numeral or notation. For purposes of clarity, not every component is labeled in every figure. Nor is every component of each embodiment of the invention shown where illustration is not necessary to allow those of ordinary skill in the art to understand the invention.

### BRIEF DESCRIPTION OF THE DRAWINGS

The preceding summary, as well as the following detailed description of the invention, will be better understood when read in conjunction with the attached drawings. For the purpose of illustrating the invention, presently preferred embodiments are shown in the drawings. It should be understood, however, that the invention is not limited to the precise arrangements and instrumentalities shown.

FIG. 1 is a flow chart illustrating the portion of the claimed method that pertains to the initiation and termination of service sessions, to the entry and resolution of service requests, and to the entry of customer feedback.

FIG. 2 is a block diagram depicting possible embodiments of the claimed system.

FIG. 3 is a flow chart showing the portion of the claimed method pertaining to the generation of individualized performance metrics and rewards points to incentivize good service and employee participation in the claimed method.

### DETAILED DESCRIPTION OF SPECIFIC EMBODIMENTS

The present invention is a method and a system to be run on computers, mobile phones, or similar devices that uses numerical identification stored on or in machine-readable objects to track individual employees and service locations. Using this tracking mechanism, the system and method permit customers to enter employee-specific or service location-specific service requests into the system, and to leave employee-specific or service location-specific customer feedback. Both managers and potential customers will thus be able to see feedback and other service-related data necessary to assess the quality of each employee or location's service.

Definitions: As used in this description and the accompanying claims, the following terms shall have the meanings indicated, unless the context otherwise requires:

A “client” is a business or other entity that uses the disclosed system and method to track the quality of its employees, services, or products.

An “employee” is any person to whom a client delegates duties or work, including without limitation paid employees as well as interns and volunteers.

A “service transaction” is any event when a customer interacts with a client or employee in the scope of the services offered by the client, or within the scope of the employee's duties to the client. Examples of service transaction include without limitation any interaction between salespeople and customers in a retail setting, whether or not a sale takes place, any interaction between waiters and dining customers, a room-service order in a hotel, or a ride in a cab or limousine.

A “service location” is any place or object that can be linked to a set of services that a customer can purchase. For example, a hotel room, a taxicab, a menu, or a barbershop could all be service locations.

A “customer” is a customer of a client using the system and method described herein. Any person who interacts with a client or any employee of a client within the scope of the employee's job-related duties to the client sufficiently to request a service or product or to render feedback concerning a service or product is a customer as used herein.

An “identifier” is a datum that uniquely identifies an employee, product, or service location within a given group (e.g. the employees of a client company), and which can be used to associate data with that employee, product, or service transaction. An identifier can be any arrangement of binary data (bits) that is unique to the given employee, including strings of numbers, characters, and other symbols.

An identifier's “team association data” is data codifying the work relationships between the employee or service location identified and other employees or service locations. For example, the team association data for an employee identifier would list the identifier of the employee's manager, the identifiers of any co-workers that work with the employee as a team, and the service location or locations at which the employee performs his or her duties. A service location's identifier would describe the employees that work at that service location.

A “service session” is a data structure or other systematic approach to data processing designed to link together a set of inputs common to a single service transaction, by associating each such input with the identifier of the service provider performing the services. For example, if a customer checks into a hotel room and enters its identifier into the claimed system, it initiates a service session, which might be a variable specifically created to store or link related data, or might be implemented by some other means. The customer's subsequent orders and feedback will be automatically linked to the identifier until somebody commands the system to end the service session or the session ends automatically. The purpose of a service session is to prevent the customer having to reenter an identifier for each request or feedback order made pursuant to a particular service transaction.

“Feedback data” is any information a customer enters to describe a service transaction that has occurred in the past, a product the customer has sampled, or an employee with whom the customer has interacted, and to describe the customer's opinion of that service transaction, product, or employee in qualitative, or quantitative terms.

A “service request” is a request for a service that a particular employee or service location is intended to perform on demand by a customer in the instant context.

To “message” is to send information immediately to somebody by electronic means. “Messaging” includes without limitation sending emails, text messages, instant messages, numerical pages, or telephone calls.

“Contact information” is any data the possession of which makes it possible to communicate with a person. Contact information includes without limitation electronic mail addresses, screen names, social network usernames, phone numbers, and residential and work addresses.

“Customer data” is any information entered into the claimed system by a customer, including any feedback data, service requests, or contact information.

A “badge” is a physical object that stores or displays an identifier. In the case of identifiers corresponding to employees, a badge may be worn on the employee's person. A badge can also be attached to a product or service location. Methods for storing or displaying an employee identifier on a badge can include, without limitation, Universal Product Code (UPC) and other bar codes, Quick Read (QR) code matrices, Radio Frequency Identification (RFID) tags of all kinds, Near Field Communication (NFC) tags, magnetically encoded data, printed text on the surface of the badge, and any other medium of data storage that can be read electronically and converted to the intended binary signal.

An “electronic device” is any computer, mobile phone, PDA, server, or any other device powered by electricity that may be programmed to perform arithmetic and logical operations.

A product or means is “coupled” to an electronic device if it is so related to that device that the product or means and the device may be operated together as one machine. In particular, a piece of electronic equipment is coupled to an electronic device if it is incorporated in the electronic device (e.g. a built-in camera on a smartphone), attached to the device by wires capable of propagating signals between the equipment and the device (e.g. a mouse connected to a personal computer by means of a wire plugged into one of the computer's ports), tethered to the device by wireless technology that replaces the ability of wires to propagate signals (e.g. a wireless BLUETOOTH® headset for a mobile phone), or related to the electronic device by shared membership in some network consisting of wireless and wired connections between multiple machines (e.g. a printer in an office that prints documents to computers belonging to that office, no matter where they are, so long as they and the printer can connect to the internet).

“Identification scanning means” as used herein is a general term for all equipment coupled to an electronic device that may be used to capture and record in digital form identifiers stored in or on badges. Identification scanning means includes, without limitation, laser scanners or digital cameras for reading bar codes, optical scanners or digital cameras for reading QR codes or printed text, RFID readers, NFC readers, magnetic readers, and any other electrical component capable of capturing a pattern in solid shapes, variations in electromagnetic forces or radiation, variations in heat or pressure, or the output of any method for signal storage or propagation.

An electronic device's “manual data entry means” is the set of data entry components coupled to the electronic device that permit the entry of data by manual manipulation, or devices designed to simulate such entry. Manual data entry means can include keyboards, mouses, touchscreens, track-pads, and signature pads. It can also include facilities to allow a person to enter text orally as if it were typed; a well-known functionality frequently exploited by persons for whom typing is unwieldy or harmful.

An electronic device's “communication means” is any facility coupled to the electronic device that enables it to transmit data to other devices. Communication means includes without limitation wireless and wired network connections, with all necessary attendant modem or other facilities, and peer-to-peer communication facilities such as infra-red or BLUETOOTH® connections.

An electronic device's “clock means” is the combination of hardware and software coupled to the electronic device that enables the electronic device accurately to measure the passage of time. Practitioners of ordinary skill in this invention's technical field will be aware that conventional computers and mobile devices routinely possess built-in clocks that can calculate the current time and date, permitting the computer or mobile device to display that time and date for a user or to “timestamp” a file stored in memory. Some electronic devices connected to networks also have the ability to correct their clocks with information downloaded from the networks to improve precision and reflect any locally-mandated clock changes (such as daylight savings time); such network-based enhancements are also part of the device's clock means.

“Computer program medium” and “computer usable medium” are used to generally refer to media capable of storing computer memory, such as removable storage units and hard disks installed in hard disk drives. Computer program medium and computer usable medium may also refer to memories, which may be memory semiconductors (e.g. Dynamic Random Access Memory). Further examples of computer useable media include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, and Nano-technological storage device), and communication media (e.g., wired and wireless communications networks, local area networks, wide area networks, and intranets).

“Sorting” means arranging a given set of data according to some order based upon characteristics common to every datum in the set. For example, dates and times may be sorted by ascending or descending chronological order, numbers may be sorted according to absolute values, and words can be sorted by dictionary alphabetization. Records can be sorted according to any data field in the records, and secondarily sorted by another field. For example, a record could be sorted by employee name, and then all records under each employee name could be sorted chronologically.

“Filtering” means excluding members from a data set if they contain or do not contain a particular element. For instance, one could filter a set of words by excluding all that do not contain the letter “A,” or by excluding all that do not start with the letter “A.” Likewise, a system could use filtering to exclude all database records not containing a particular identifier.

An “individualized performance metric” is a number calculated using feedback data and service requests to measure the quality of the product or service pertaining to a particular identifier. For example, if the feedback data for a given service includes asking the customer to rate the quality of service from 1 (poor quality) to 5 (best quality), the average of all the customer ratings could be an individual performance metric.

“Rewards points” are units of count in scoring the performance of an employee, a predetermined quantity of which may be exchanged for a reward, which may be a good or service of the client's selection. As an example, the client could provide that ten of any employee's rewards points could be exchanged for a free haircut at a particular barbershop.

A “rewards points balance” is the sum of all rewards points that an employee has earned, but has not yet exchanged for a reward.

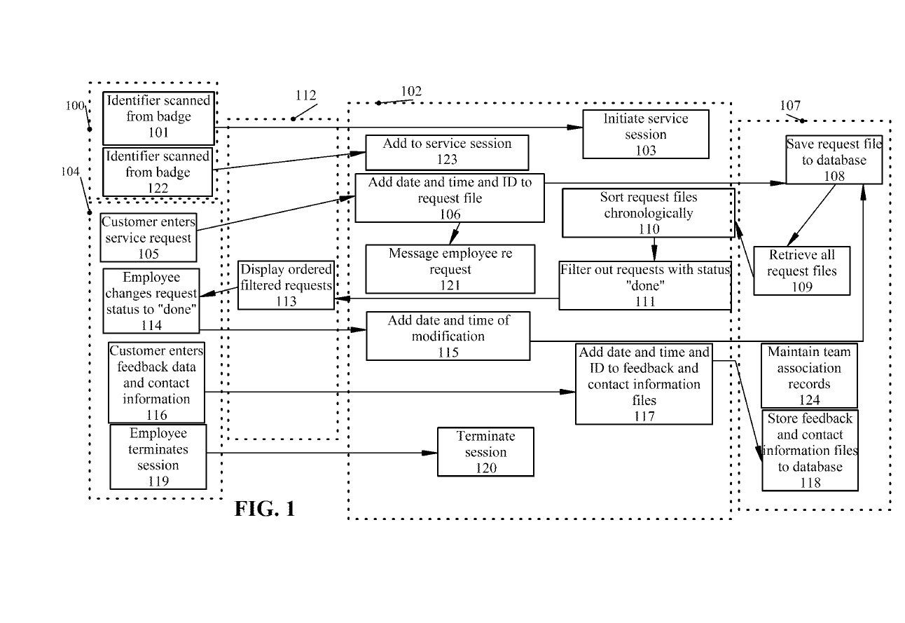

The flowchart in FIG. 1 illustrates the following example of how one possible embodiment of the claimed method and system would function in practice. A customer checks into a hotel room. Next to the door is a QR code stuck to the wall, which the customer's mobile phone can scan 100 and enter into a version of the claimed system installed on the phone. Scanning the code prompts Processing Component software 102 to initiate a service session 103 on the system. This service session will remain active throughout the customer's stay, linking the system running on the customer's phone to that particular hotel room. If the customer wishes to request a service with regard to the hotel stay, to order more towels, for instance, or to ask for a shuttle ride somewhere to the nearby community, the customer can enter the request as text 105 into the electronic device via its manual data entry means 104; the device's Processing Component software 102 adds the date and time of entry of each request to its file 106, before directing the device's Data Storage software 107 to enter the service request file 108 to a database coupled to the customer's device. On a computer at the hotel front desk, the clerks can view a queue of orders to be completed by room, which the system produces by periodically retrieving all service orders 109 associated with each room's identifier, sorting the service orders chronologically 110, and filtering out 111 all orders whose status reflects that they were completed, prior to display 113 by the system's User Interface Component software 112. Upon completing the requested service, a clerk updates the service request status to “done” 114, and the Processing Component 102 adds the date and time of the status change to the service request data file 115 before directing the Data Storage software 107 to save the file 108 as modified. When the system redisplays the service requests for that room, the completed request will be filtered out in the filtering stage 111, and thus will not display in the queue of current service requests. At checkout, the customer completes a short survey on the customer electronic device 116, which adds the date and time the feedback was entered 117 and saves the feedback to the database as well 118. Finally, when the check-in desk resets the key cards they also command the system to terminate the service session 119. In response, the system terminates the service session 120. If during his or her time in the hotel the customer encounters a flooded bathroom on another floor, the customer could start a new service session by scanning the bathroom's badge 100, and entering a service request asking for the bathroom to be cleaned; that service session could terminate automatically 120 upon the request's completion. In addition to making the customer's stay more convenient, the system has allowed the customer to rate the quality of service that he or she received. The hotel management can see not only the customer's rating, but also the time that elapsed between each service request and its completion, allowing the hotel management to gauge the promptness of the service delivered to that room during that customer's stay.

The simplest embodiment of this invention is directed solely to the collection of employee-specific or service-location specific data. The method involves entering the employee or service-specific identifier into an electronic device from a badge 101 by identification scanning means as defined above. The use of a badge to store the identifier provides a way to track employees and service locations that matches the efficiency of a product UPC system. It also eliminates the possibility of most error; as scanning is a very accurate process that extracts the desired information automatically, neither the customer nor any employee need spend any time or effort on verifying that the code is correctly entered. The entry of the identifier automatically starts a service session 103, initializing the software so that all subsequent customer data entered 105, 116 will be linked with the identifier. The customer enters the data on the customer's device, and the system adds the data and time of entry to the data file thus created 106, 117. As a result, the custom data file will contain at minimum one identifier, one item of customer data, and one field containing the date and time the custom data file was created. This custom data file is saved 108, 118 to a database. In most implementations, the service session is terminated 120, either by a command to terminate it entered by an employee 119 or automatically when some set of circumstances have occurred. The latter case might include a lack of activity pertaining to that service session over some period of time, or some pre-determined set of customer data the entry of which would indicate a completed transaction. The termination of a session is useful because it frees up system resources; particularly where the service session is a variable or data structure, it may involve allocation of data which, in the aggregate, could drastically slow down a system or use up its available memory. However, the decision about how or when to terminate a session, or indeed how to create it, is implementation-specific. The case in which a customer must scan a badge for each entry of customer data is simply a single-entry session, which of course requires no system implementation at all.

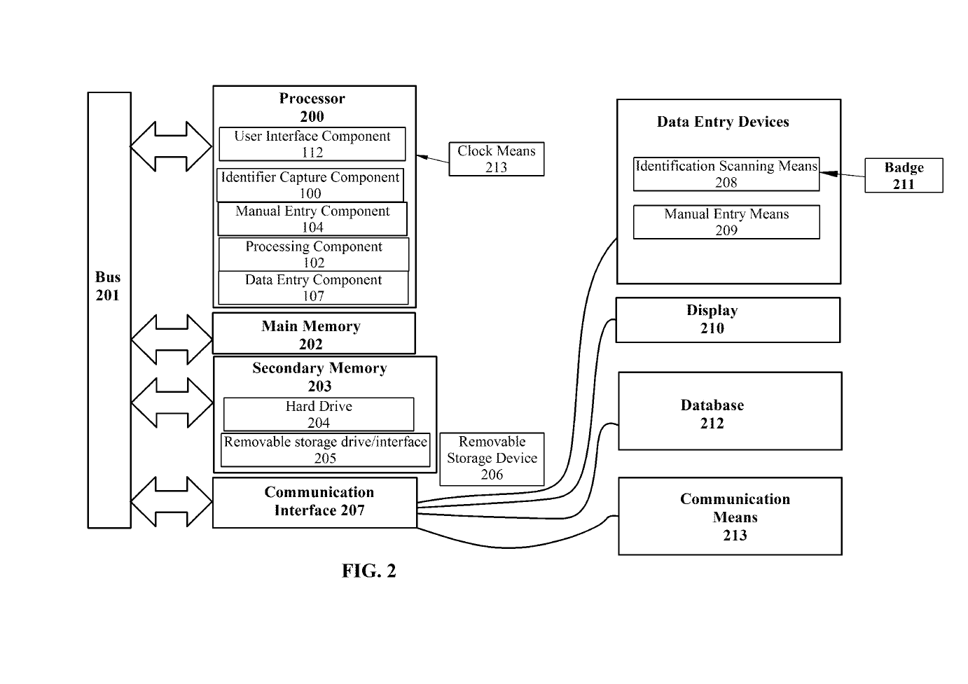

The equivalent system embodiment is an electronic device as defined above, configured to perform the method just described. An exemplary electronic device is illustrated by FIG. 2. The processor 200 may be a special purpose or a general-purpose processor device. As will be appreciated by persons skilled in the relevant art, the processor device 200 may also be a single processor in a multi-core/multiprocessor system, such system operating alone, or in a cluster of computing devices operating in a cluster or server farm. The processor 200 is connected to a communication infrastructure 201, for example, a bus, message queue, network, or multi-core message-passing scheme.

The electronic device also includes a main memory 202, such as random access memory (RAM), and may also include a secondary memory 203. Secondary memory 203 may include, for example, a hard disk drive 204, a removable storage drive or interface 205, connected to a removable storage unit 206, or other similar means. As will be appreciated by persons skilled in the relevant art, a removable storage unit 206 includes a computer usable storage medium having stored therein computer software and/or data. Examples of additional means creating secondary memory 203 may include a program cartridge and cartridge interface (such as that found in video game devices), a removable memory chip (such as an EPROM, or PROM) and associated socket, and other removable storage units 206 and interfaces 205 which allow software and data to be transferred from the removable storage unit 206 to the computer system.

The electronic device may also include a communications interface 207. The communications interface 207 allows software and data to be transferred between the electronic device and external devices. The communications interface 207 may include a modem, a network interface (such as an Ethernet card), a communications port, a PCMCIA slot and card, or other means to couple the electronic device to external devices. Software and data transferred via the communications interface 207 may be in the form of signals, which may be electronic, electromagnetic, optical, or other signals capable of being received by the communications interface 207. These signals may be provided to the communications interface 207 via wire or cable, fiber optics, a phone line, a cellular phone link, an RF link or other communications channels. The communications interface in the system embodiments discussed herein facilitates the coupling of the electronic device with identification scanning means 208, manual entry means 209, and the device's display 210. It should be noted that each of these means may be embedded in the device itself in some embodiments.

Computer programs (also called computer control logic) are stored in main memory 202 and/or secondary memory 203. Computer programs may also be received via the communications interface 207. Such computer programs, when executed, enable the processor device 200 to implement the system embodiments discussed below. Accordingly, such computer programs represent controllers of the system. Where embodiments are implemented using software, the software may be stored in a computer program product and loaded into the electronic device using a removable storage drive or interface 205, a hard disk drive 204, or a communications interface 207.

Persons skilled in the relevant art will also be aware that while any device must necessarily comprise facilities to perform the functions of a processor 200, a communication infrastructure 201, at least a main memory 202, and usually a communications interface 207, not all devices will necessarily house these facilities separately. For instance, in some forms of electronic devices as defined above, processing 200 and memory 202 could be distributed through the same hardware device, as in a neural net, and thus the communications infrastructure 201 could be a property of the configuration of that particular hardware device. Many devices do practice a physical division of tasks as set forth above, however, and practitioners skilled in the art will understand the conceptual separation of tasks as applicable even where physical components are merged.

One system embodiment uses the identification scanning means 208 to scan an identifier in from a badge 211, which the processor 200 is configured to record by a computer program creating an Identifier Capture Component 100. A User Interface Component, also created by a computer program, 112 prompts the entry of customer data, which is entered via manual entry means 209 and captured by the Manual Entry Component 104, which is also created using a computer program. Skilled practitioners in the art will know about the varied categories of user interfaces, from the command-line textual interfaces still used on many UNIX machines to the graphical user interfaces that combine keyboard inputs with images to select using mouses, track pads, and touch screens, among other things. A further computer program creation, the Processing Component 102, accepts the identifier and customer data, creates and terminates sessions, and combines the customer data with the identifier and the date and time of the customer data's creation, produced by clock means 213 coupled to the device, to produce custom data files. The Data Storage Component 107 stores these data files to a database 212. As persons skilled in the art will know, a database 212 is a structured collection of data, which can divide the data stored into fields representing useful categories of data. As a result, a stored data record can be quickly retrieved using any known portion of the data that has been stored in that record by searching within that known datum's category within the database. A database can be created in any digital memory. Likewise, any system embodiment of this invention could involve one or more electronic devices as portrayed in FIG. 2. In particular, the database 212 could be maintained on a centralized electronic device acting as a data server, while the customer data could be entered on a separate electronic device in a different location. Furthermore, it is worth noting that the Processing Component 102, Data Storage Component 107, Identifier Capture Component 100, Manual Entry Component 104, and User Interface Component 112 need not be separate entities or modules within a particular program as implemented. The purpose of their status as elements in the system described herein is to establish that the processor 200 must be configured to perform their functions as set forth, but not to dictate the architecture of a particular implementation. Practitioners skilled in the art will be aware, for instance, that data sorting can take place at many points in a particular program, including during the initial extraction of data from a database 212.

Further embodiments of the method claimed, as illustrated by FIG. 1 involve entering customer data in the form of service requests 105. Service requests, at their most basic, would consist solely of a customer's text entry describing the desired service. Clients may find it expedient to guide the customer toward appropriate requests by organizing the User Interface Component 112 to restrict data entry options. Techniques for such restrictions are ubiquitously used, and practitioners in the art will be familiar with drop-down lists, radio buttons, check-boxes, and other software conventions designed both to show the customer available options and to eliminate inappropriate entries. As with all customer data, the service requests will be combined with the identifier and with the date and time of the request's entry 106, then stored 108 in the database. The corresponding system embodiment, illustrated by reference to FIG. 2, requires additional configuration of the Processing Component 102 and the Data Storage Component 107, which while assembling and storing the custom data file pertaining to a service request can treat it in such a way as to make it more readily useful. For instance, the Data Storage Component 107 could be configured to store the file to a table in the database 212 dedicated exclusively to service requests. Alternatively, both the Processing Component 102 and the Data Storage Component 107 could be designed so that a field indicating the nature of the custom data file (e.g. a numerical field whose value was “1” for service requests, and “0” otherwise) could be appropriately populated, and stored in the database 212. Practitioners skilled in the relevant art will be aware that the database 212 would need to be configured appropriately to accept either solution, and that the design of the Processing Component 102 and Data Storage Component 107 would need to incorporate the ability to relay the data's status as a service request, by passing a variable designed along the lines of the above-described numerical field, or by the creation of dedicated functions or data structures to the creation and processing of service requests, among many other recognized options.

Augmenting the usefulness of the service requests is an additional embodiment, as shown in FIG. 1, which includes sending a message 121 to an employee in a position to complete the service request. The message could consist of a text message, an electronic mail message, a numerical page of a number that the employee can decode to determine the category of service requested, or any other form of electronic communication that serves to inform the employee of the request's existence. The purpose of this addition to the method is to ensure prompt attention to service requests. The corresponding system embodiment involves configuring the Processing Component 102 to send the message via communication means 213 coupled to the electronic device. Persons skilled in the relevant art will be aware that electronic devices typically have built-in communication interface 207 devices such as wireless antenna of smart-phones, wireless local network connection (also known as “wi-fi”) facilities, or ethernet ports, with which to connect to various wireless and wired networks. When connected, those interface devices, combined with the network to which they are connected, constitute communication means 213. As persons skilled in the relevant art will also be aware, there are many well-known ways to send information very rapidly using such communication means, including electronic mail, instant messaging, texting, paging, and phone calls.

Another embodiment of the method, as illustrated in FIG. 1, involves entering feedback data 116 as some of the customer data. As mentioned in the last paragraph, practitioners skilled in the art will know of many common user interface 112 techniques to guide the input of feedback data. Thus, the feedback data 116 could contain one or more fields of text describing the customer's experience, and one or more numerical fields rating various aspects of the customer's experience on a scale (e.g. 1 to 5, with 1 meaning “terrible” and 5 meaning “excellent” from the customer's point of view). For instance, in a restaurant, the customer might scan a badge attached to or brought to his or her table. The customer could then be prompted to enter numerical ratings and comments describing the quality of service, the ambiance, cleanliness, quality of food, and various other aspects of the dining experience. This data, like all customer data, is combined by the Processing Component 102 with the date of entry and the identifier 117 prior to storage 118. The equivalent system claim (as illustrated by FIG. 2) requires as before that the Processing Component 102 and Data Storage Component 107 be configured to differentiate between feedback data and other customer data, and ideally to store the feedback data in a manner that aids in its later retrieval.

The customer may also enter contact information 116 in another embodiment of the claimed method, as illustrated in FIG. 1. As before, the Processing Component 102 adds 117 the date and time of entry, as well as the identifier, to the file containing the contact information, which is stored 118 in the database. By storing this contact information, the client gains the ability to email customers special offers, such as sales on products or services. Furthermore, by collecting the contact information of customers, the client is in a position to offer incentives for those who take the time to enter feedback, using gift cards or special sales. The corresponding system embodiment FIG. 2 involves configuring the Manual Entry Component 104 to accept the entry of contact information, configuring the Processing Component 102 to add the identifier and date and time of entry to the custom data file containing the contact information as with other customer data, and configuring the Data Storage Component 107 to store the contact information custom data file to a database 213. The database 213 can be arranged to contain a separate table for contact information, or the table or tables containing feedback data can have an additional field that contains the contact information.

In some situations, FIG. 1 there is more than one employee or service location to with regard to which the customer could enter feedback data 116 or service requests 105. In that case, it would be desirable for the customer to be able to enter customer data that relates to more than one identifier. There are several ways to achieve this. One way is to allow the creation of multiple service sessions; skilled practitioners will be aware that the ability to open several instances of a software product at the same time is a common feature in contemporary software development. Another way to accomplish the same thing is by adding the method step of scanning in one or more additional identifiers 122. These can be added to the service session 123 so that when the Processing Component 102 adds the identifier to customer data files 106, 117 it also includes the newly added identifier, which is then stored 108, 118 with the rest of the custom data file. As the corresponding system embodiment FIG. 2 would demonstrate, this requires that the database 213 be configured to store the additional identifier or identifiers, either in a separate field or table, or in the same field in a manner that allows the Data Storage Component 107 or Processing Component 102 to separate the identifiers when appropriate. Techniques to perform the latter option are well-known to persons skilled in the relevant art; one way of transmitting data records for example is in the form of a fixed-length string that can be separated into component data fields by character count. A similar method is a variable-length string containing special symbols, called “tokens,” that a parsing program reads as separating one data field from the next. Whatever the approach used to implement this embodiment, it will require adjustments to the Identifier Capture Component 100 to accept an additional identifier, as well modifications to the Processing Component 102 to enable adding the additional identifier to data files and the Data Storage Component 107 to store the additional data as part of the file written to the database 213.

Another way to make sure that service requests and feedback data are associated with the appropriate identifiers is to make the system FIG. 2 aware of the associations between employees as team-members or as managers and subordinates, and of the relationships between employees and service locations. To accomplish this, the system can maintain data consisting of associations between identifiers in a database 213. Thus, for example, the identifier corresponding to an employee could be stored in a database record containing a list of identifiers of team members, or peer employees, whose performance as a team is affected by, and reflected in, the employee's own performance. Likewise, the data record could contain the identifier of the employee's manager, and the identifier of a service location at which the employee performs his or her duties. The method embodiment FIG. 1 of this technique involves maintaining 124 team association records in a database. The existence of the records creates a natural association of feedback data ascribed to one identifier with the other identifiers that may be affected by that feedback data. For instance, if a restaurant customer reviews the service he or she receives from a particular waiter, the association data links that review to the restaurant the waiter works at, and the table the waiter served that night.

Another feature of some method embodiments involves the retrieval 109 of previously stored customer data records, along with associated data such as the team association data described above, and their display 113. This feature enables a client company or customer to see all of the feedback associated with a given employee or service location; the ability to use that information to make informed decisions is one of the great benefits of this invention. Likewise, an employee could review the service requests that fell within his or her responsibilities. It should be apparent to skilled persons in the art that the retrieval of data records in which a particular field matches a value, or a range of values, is a basic feature of databases and database querying languages. The corresponding system modifications FIG. 2 would involve configuring the Data Storage Component 107 to query the database for its records, and configuring the Processing Component 102 and the User Interface 112 to organize the data for display.

The usefulness of the retrieved records is greatly enhanced by the ability to sort 110 and to filter 111 them FIG. 1. Sorting, as defined above, could be used to arrange data files in chronological order, and also to array them by category, among other things. For instance, where feedback data 116 is involved, sorting by one category of numerical rating naturally groups identical ratings together, allowing a customer to peruse the records associated with them and to read the comments that accompany a particular rating within the category. If a client was interested in observing correlations between positivity of numerical ratings and length of textual comments, to give another example, sorting by length of comment could greatly simplify matters. Filtering 111 is of equal value: one way to ensure that a customer sees solely past feedback and not service requests is to filter the latter out. Likewise, service requests can be filtered to eliminate those records that indicate the requests were completed.

The system embodiments FIG. 2 to effect the sorting and filtering functionality require programmatic modifications to the Processing Component 102. Skilled practitioners will be aware of many efficient sorting methods, from variously optimized algorithms embedded in object-oriented languages to simple and fast techniques to write from scratch. Practitioners will know in particular that databases 212 are typically able to sort data fields very rapidly when commanded to do so by an appropriate query. The most efficient approach in complex cases is often to perform some initial high-volume sorting during data retrieval, followed by more processing-intensive forms of searching at later stages. Filtering is arguably the basis of all database 212 querying, and can be done very rapidly when the data is retrieved. However, the filtering can also occur at virtually any point in data processing, from querying to display. Furthermore, skilled practitioners will be aware that data is frequently processed during programs using data structures that separate data into different categories depending on its contents. For example, the data structure used to process service requests could itself distinguish between completed requests and non-completed requests, for example through the use of a boolean variable, which would initially be set to “false” and switch its value to “true” to indicate completion when that option was selected in the user interface 112. In that case, the most efficient filtering solution could be to place all requests known to be completed by virtue of that variable into a distinct table within the database 212; the filtering process occurs in that case prior to the data's initial insertion by the data entry component 107 to the database 212, and as a result the initial search for service requests involves far smaller volumes of data. Thus, practitioners will understand that many different variations are possible in embodiments that filter and sort data.

As the foregoing discussion implies, some embodiments of the claimed method involve retrieving some previously entered data and permitting the user to modify some field in a particular data file or in a group of data files. As a method FIG. 1 this is straightforward. The data is retrieved from the database 109, filtered 111 and sorted 110 as needed, then displayed 113 by the User Interface Component 112. The user can then modify a field, for example by changing the status of a service request to “completed” 114 using the device's manual entry means. In the example shown, the Processing Component 102 modifies the data further by adding the date and time of modification 115 to the data. The ability to make automatic modifications like this is an important aspect of those embodiments that permit data modification, because it allows the interactions with users to be simple and intuitive; an electronic device with a clock means, for instance, is able much more easily to compute the exact time and date and enter it consistently. Finally, the Data Storage Component 107 stores the modified record to the database 108. Skilled practitioners will be aware, as noted above, that the modifications made could be reflected both as data fields within a table and as decisions in the Data Storage Component 107 to store the data in a different table within the database; either option gives the correctly designed system the ability to derive the data modification accurately, and the choice of implementation should be governed by the requirements of efficiency, which may change depending on the volume and diversity of the data to be processed.

The corresponding system embodiment FIG. 2 requires configuring the Manual Entry Component 104 to accept any user changes. In practice, the User Interface Component 112 could also be modified to prompt the appropriate modifications, for example by allowing the user to select a data field and edit it, or alternatively by displaying the same screens that allowed initial entry and allowing the user to edit entries there. The Processing Component 102 must also be modified to receive the changes and to add the date and time of the modification, as generated by the device's clock means 213. The configuration of the Processing Component 102 to receive the user-entered modifications often involves allowing the Processing Component to make changes of its own, as skilled practitioners will be aware. For instance, if the user sets the status of a service request to “completed” in the User Interface Component 112, the Processing Component 102 could store that selection as a boolean, numerical, or textual variable, or it could instantiate a different category of data structure for the sake of processing completed service requests. In addition to the stated addition of the date and time of modification, this could involve the creation of other related data necessary for the efficient processing of the service request.

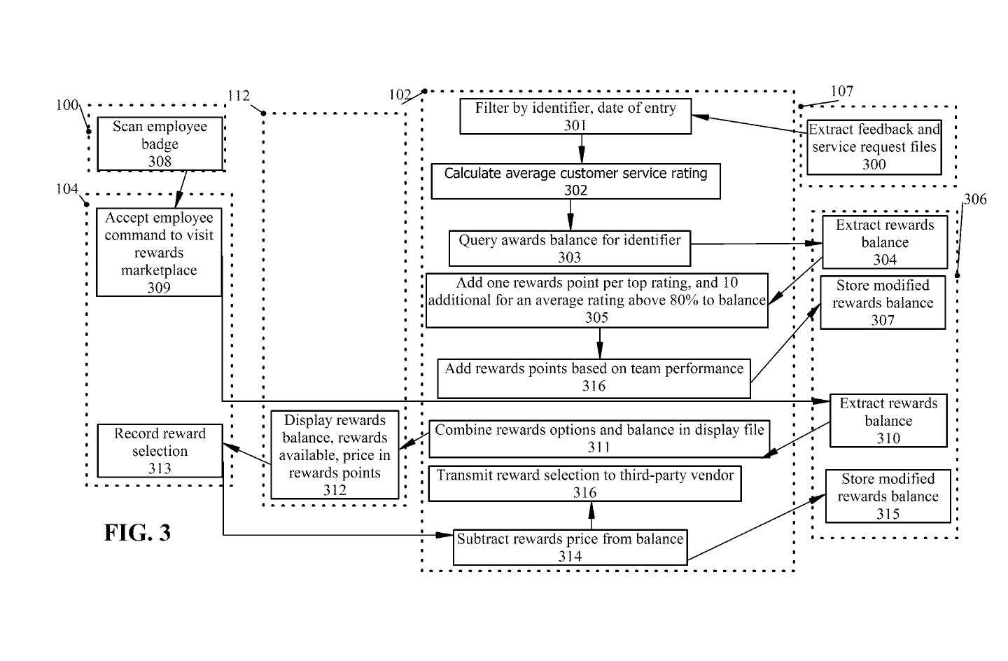

Another set of potential method embodiments illustrated by FIG. 3 use previously entered data to calculate individualized performance metrics 302. As defined above, individualized performance metrics are numerical measures of quality of service, as derived from the data. For example, where feedback data contains numerical rating scales entered by the customers, an individualized performance metric that might be useful would be the average score 302 associated with a given identifier. Another useful metric would be the number of top scores 305 associated with that identifier. As persons skilled in the art will realize, there are many more calculations that may be made with the data as described herein to assess quality of service. Moreover, the metrics are not limited to calculations concerning feedback data. In an embodiment in which employees update service requests to “completed,” for example, the Processing Component 102 could calculate the length of time that elapsed from the initial entry of a service request to the entry of its “completed” status. Those time periods could also be averaged, the standard deviation from the average could be calculated, and the number of particularly fast or slow task completions could be tallied. The service requests could also be measured by category to determine which particular task was proving too lengthy, and service requests that took an unusually long time could be matched with the customer's feedback to assess whether the performance lag was acceptable or not. Finally, using the team association data stored in the database as discussed above, the individual performance metrics could be calculated using both individual and team records (see FIG. 3, 316). Thus, for example, individualized performance metrics can be calculated based on the performance of entire teams of employees, service location metrics can be used as a measure of individual employees' performance, and employees' performance metrics can be used as the basis for the performance metrics of the employees' manager. In addition, overall performance metrics of stores or restaurants in chains could be compared to one another, with rewards points prizes for the top performers.

The system FIG. 2 embodiments of this functionality would involve changes to the Processing Component 102. The calculations could be performed in batch form, by processing all of the data for a given identifier or group of identifiers that falls within a certain time span after that time span has concluded (e.g. once a week), or they could be re-calculated every time a new data entry associated with an identifier appeared. Particularly in the latter case, practitioners skilled in the art will recognize that maintaining previously calculated individual performance metrics in a database 212 can greatly optimize calculations, by obviating the need to recalculate with regard to old data points. Whether such optimizations are desirable depends on the volume of data involved.

Where the identifier pertains to employees, an additional enhancement to the method FIG. 3 involves using the individualized performance metrics to assign rewards points to the employee 305. Rewards points, as defined above, may be exchanged by the employee for goods and services selected by the client. The purpose of this arrangement is to create incentives, not only to perform excellent service, but also to ensure that the feedback and service request data is diligently maintained. An employee will derive the most benefit from this system if he or she updates any data that he or she is required to update, and moreover if the customer remembers to enter feedback reflecting positive service. Thus, the employees will be encouraged to find ways to convince customers to enter feedback. As a result, the client not only achieves better customer service, but also acquires a greater wealth of data concerning that service. How exactly to decide what behaviors to reward, and by how much, is a question of economics and psychology to be determined by the client. The calculation of rewards points itself is potentially quite simple: the client could choose a positive performance metric, such as a top score in the customers' numerical feedback entries 305, and assign rewards points 305 each time that metric is achieved. Reward points could also be assigned based on average values 302 such as the average score received for a given numerical feedback category. In addition, as noted above, the existence of team association data permits the assignment of rewards points based upon the performance of teammates, subordinates, or the service location 316. The rewards points are maintained in a rewards points balance 304 maintained in a database 306. Every time new rewards points are calculated, they are added 305 to the rewards points balance, which is stored in its updated form 307 in the database 306.

The corresponding system embodiment FIG. 2 would require that the Processing Component 102 be modified to perform the assignment of rewards points and add them to the rewards points balance. This modification could involve directly programming in the rewards points assignments by the creation of what skilled practitioners would call static variables, or it could involve storing them either in the machine's main memory 202 or secondary memory 203. Alternatively, the rewards values could be stored in a database 212. The Data Storage Component 107 must also be modified to store and retrieve rewards points balances from the database 212 that maintains them.

Finally, a set of method embodiments FIG. 3 provide the employees with a marketplace in which to redeem their rewards points. To do so, an employee who has entered his or her identifier into the system 308 prompts 309 the Manual Entry Component 104 to retrieve his or her rewards points balance 310, which is done by the Data Storage Component 107. The User Interface Component 112 displays the rewards points balance and offers the employee with reward selections to choose 312. When the employee selects a reward 313, its price in rewards points is subtracted from the rewards points balance 314, which is stored 315 in its modified form in the database. There are many possible ways to process the employee's reward selection after this point. The selection could be immediately transmitted to a third-party vendor 316, who would send the product or arrange the service for the employee. As skilled practitioners in the art will know, electronic devices can communicate via network or wireless connections with other entities, so the automatic transmission of a reward selection would be a trivial matter to implement. Alternatively, the reward selection could be printed out in the form of a coupon redeemable with the vendor of the product or service selected, or stored in a database.

The system FIG. 2 embodiment of this feature requires that the User Interface Component 112 be configured to display the rewards points balance and the potential rewards selections. The Manual Entry Component 104 must likewise be configured to accept the employee's selections, the Processing Component 102 must be configured to subtract the price of selected rewards from the rewards points balance, and the Data Storage Component 107 must be configured to store the modified balance in the database 212 that maintains the rewards points balance. Of course, depending on how the rewards selection is processed, the Processing Component 102 may need further configuration to command transmission or printing of the selection, and the Data Storage Component 107 might need further configuration to store reward selections.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. A method for entering employee, product, or service-specific customer reviews and service requests using at least one electronic device, comprising:
providing at least one badge identifying an employee, product, or service location;
starting a service session by extracting said badge's identifier using identification scanning means coupled to said electronic device or devices;
entering customer data using manual data entry means coupled to said electronic device or devices;
assembling said identifier and customer data into one or more custom data files;
incorporating the date and time of the entry of the customer data pertaining to each custom data file, as generated by clock means coupled to said electronic device or devices, into that custom data file; and
storing each said custom data file on a database coupled to said electronic device or devices.

2. A method according to claim 1 wherein the customer data includes at least one service request.

3. A method according to claim 2 further comprising messaging at least one employee concerning a service request, using an electronic device or electronic devices' communication means.

4. A method according to claim 1 wherein the customer data includes feedback data.

5. A method according to claim 1 wherein the customer data includes contact information.

6. A method according to claim 1 further comprising scanning an additional badge, adding said additional badge's identifier to the service session, and adding said additional badge's identifier to said custom data files.

7. A method according to claim 1 further comprising maintaining team association data for each identifier in a team association database.

8. A method according to claim 1, further comprising:
retrieving previously entered custom data files and related data from said database;
sorting the retrieved data files by data fields;
filtering the retrieved data files by data fields; and
displaying them on an electronic device.

9. A method according to claim 8 further comprising:
altering one or more data fields in a displayed custom data file using manual data entry means coupled to said electronic device or devices;
adding the date and time of said alteration, as generated by clock means coupled to said electronic device or devices, to said custom data file; and
saving the alteration to said custom data file in the database entry containing said custom data file.

10. A method according to claim 8 further comprising calculating individualized performance metrics using data in said custom data files.

11. A method according to claim 10, further comprising:
maintaining a numerical rewards points balance in a database record containing an identifier associated with an employee;
retrieving said rewards points balance from said database record;
comparing individualized performance metrics to predetermined goal values to assign rewards points to said identifier;
adding said rewards points to said rewards points balance; and
saving the rewards points balance thus modified to said database record.

12. A method according to claim 11 further comprising:
retrieving said employee's rewards points balance from said database record;
displaying said rewards points balance on an electronic device;
allowing said employee to purchase rewards at previously determined prices in rewards points;
subtracting said prices from said rewards points balance; and
saving said rewards price balance thus modified to said database record.

13. A system for recording and managing ratings and service requests for employees, services, and products, the system comprising:
at least one badge storing or displaying an identifier, and at least one electronic device coupled to identification scanning means, to manual data entry means, to communication means, and to clock means; each electronic device having a memory and a processor coupled to the memory, the processor operable to execute instructions to perform functions comprising:
a User Interface Component configured to display data and to prompt the entry of identifiers and customer data;
an Identifier Capture Component configured to capture identifiers generated by said identification scanning means;
a Manual Entry Component configured to capture customer data and commands to terminate service sessions, entered via said manual data entry means;
a Processing Component configured to initiate and terminate service sessions, to combine said customer data with said identifiers into custom data files, and to add to said custom data files the identifier, and the time and date of said customer data's entry, as generated by said clock means; and
a Data Storage Component configured to store said custom data files to a database coupled to said electronic device.

14. A system according to claim 13, wherein the customer data which said Manual Entry Component, Processing Component, and Data Storage Component are configured respectively to receive, process, and store includes at least one service request.

15. A system according to claim 14, wherein the Processing Component is configured to message employees concerning service requests using the electronic device or devices' communication means.

16. A system according to claim 13, wherein the customer data which said Manual Entry Component, Processing Component, and Data Storage Component are configured respectively to receive, process, and store includes feedback data.

17. A system according to claim 13, wherein the customer data which said Manual Entry Component, Processing Component, and Data Storage Component are configured respectively to receive, process, and store includes contact information.

18. A system according to claim 13, wherein the Identifier Capture Component is further configured to accept additional identifiers to associate with the service session, the Processing Component is further configured to add said additional identifiers to said custom data files, and the Data Storage Component is further configured to store custom data files containing said additional identifiers.

19. A system according to claim 13 further comprising a database that stores team association data for each identifier, and wherein the Data Storage Component is configured to retrieve said team association data for each identifier.

20. A system according to claim 13, wherein said Data Storage Component is further configured to retrieve previously entered custom data files and related data from said database, and wherein said Processing Component is further configured to sort and filter said custom data files by data fields.

21. A system according to claim 20, wherein said Manual Entry Component is further configured to allow accept an alteration of at least one data field in one of the custom data files retrieved by said Data Storage Component, and wherein said Processing Component is further configured to amend said data field according to said alteration in said custom data file and to add the date and time of modification as generated by said clock means, and wherein said Data Storage Component is further configured to store said custom data file as altered to said database.

22. A system according to claim 20, wherein said Processing Component is further configured to calculate individual performance metrics using the custom data files retrieved by said Data Storage Component.

23. A system according to claim 22:
wherein a rewards database coupled to said electronic device or devices maintains a data record containing a numerical rewards points balance for an identifier that identifies an employee; and
wherein said Data Storage Component is configured to retrieve said data record from said rewards database and to store said data record with alterations made by said Processing Component to said data record; and
wherein said Processing Component is further configured to compare individualized performance metrics to predetermined goal values to assign rewards points to said employee and to add points thus assigned to said rewards points balance.

24. A system according to claim 23, wherein said Manual Entry Component is configured to accept employee rewards selections, and wherein said Processing Component is configured to subtract said selections' prices in rewards points from said rewards points balance.
